(19) United States
(12) Patent Application Publication
(10) Pub. No.: US 2003/0183955 A1
(43) Pub. Date: Oct. 2, 2003

(54) Humidifier for forced air furnaces

(76) Inventor: Bradly R. Fields, Lake Orion, MI (US)

Correspondence Address: Paul J. Ethington, Reising, Ethington, Barnes,, Kisselle, Learman & McCulloch, P.C., P.O. Box 4390, Troy, MI, 48099-4390, US

(21) Appl. No.: 10/383,448

(22) Filed: Mar. 7, 2003

Related U.S. Application Data
(60) Provisional application No. 60/362,787, filed on Mar. 8, 2002.

(51) Int. Cl. B01F 3/04

(52) U.S. Cl. 261/106

(57) ABSTRACT

A flow through humidifier is disclosed having a water distribution tray disposed above an evaporator pad. A drip nozzle is connected with the outlet of a water supply tube and delivers discrete water drops to said water distribution tray. The drip nozzle may be located outside or inside the tray. A humidifier housing is connected with an inlet air duct which extends between a first furnace air duct and the housing and the housing outlet air duct connects with a second furnace air duct. An adjustable damperer is disposed in one of the humidifier housing air ducts for restricting air flow through the evaporator pad. In a second embodiment, water is supplied to the drip tray under control of a float valve which is actuated by a float posed in a water collection reservoir.

### RELATED APPLICATION

This application is based upon Provisional Patent Application No. 60/362,787 filed Mar. 8, 2002 entitled “Humidifier for Forced Air Furnaces” and the priority thereof is hereby claimed for this application.

### FIELD OF THE INVENTION

This invention relates to humidifiers especially for use with a forced air furnace; more particularly, it relates to a humidifier of the type commonly referred to in the trade as a flow-through humidifier.

### BACKGROUND OF THE INVENTION

The prior art is known to be replete with teachings of various humidifiers especially useful with forced air home furnaces. Many of such humidifiers are provided with complicated controls for regulating the humidity and are relatively costly to manufacture and install in the furnace system. Commonly, such humidifiers comprise control devices such as humidistats, solenoid valves, relays, motors and fans. These components not only add to the cost of manufacturing and installation but also, result in an installation which is more difficult and costly for the home owner to maintain.

The prior art includes U.S. Pat. No. 5,948,324 granted Sep. 7, 1999 which discloses a flow through humidifier. U.S. Pat. No. 2,947,452 granted Aug. 2, 1960 and U.S. Pat. No. 4,158,679 granted Jun. 19, 1979 discloses water distribution trays for humidifier.

There is a need for an improved flow through humidifier for forced air furnaces which provides regulation of humidity in the heated air and which is economical to manufacture, install and maintain. Further, there is a need for such a humidifier to be implemented in a design which is easy for the home owner to perform the necessary installation and maintenance without the aid of a service technician.

A general object of this invention is to provide an improved improved humidifier for forced air furnaces which overcomes certain disadvantages of the prior art and which is economical to manufacture, simple to install and maintain, and yet provides good humidity regulation.

### SUMMARY OF THE INVENTION

In accordance with this invention, a flow-through humidifier is provided which requires a minimum of components, provides good humidity regulation and is reliable in operation. Further, it is economical to manufacture and easy to install and maintain by an unskilled home owner.

Further, in accordance with this invention, the humidifier comprises an evaporator pad and a simplified water supply system for maintaining the pad in a controlled wetted condition. This is achieved, in one embodiment, by a water supply system which delivers water in discrete drops directly to the evaporator pad or, in an alternative design, indirectly through a water distribution tray over the pad. In another embodiment, the humidifier comprises a water supply system which delivers water in an intermittent stream controlled by a float valve with the intermittent stream impinging directly on the evaporator pad or, alternatively, with the stream passing through a water distribution tray to the pad. Additionally the pad may be welted by wicking action of the pad form a water pan with float valve control of the water level.

Further, in accordance with this invention, a humidifier is provided with an improved air flow system which comprises an adjustable damper for regulating the humidity.

A complete understanding of this invention will be obtained from the detailed description that follows taken with the accompanying drawings.

### DESCRIPTION OF THE DRAWINGS

FIG. 1 is an exploded perspective view of a first embodiment of the humidifier of this invention;

FIG. 1A is perspective view showing part of a water supply system of the humidifier of FIG. 1;

FIG. 1B is a modification of the water supply system;

FIG. 2 is an exploded perspective view of the second embodiment of the humidifier of this invention;

FIG. 2A is a perspective view of part of the water supply system of the humidifier of FIG. 2;

FIG. 3A is an exploded perspective view of a drip nozzle used in the water supply system of humidifier of FIG. 1;

FIG. 3B is a perspective view of the drip nozzle of FIG. 3A;

FIG. 4A is a exploded perspective view of another drip nozzle used in the water supply system of the humidifier of FIG. 1;

FIG. 4B is a developed view of the drip nozzle of FIG. 4A;

FIG. 5 is a modification of the water supply system of the first embodiment of the humidifier of this invention; and

FIG. 6 is a perspective view of a modified air flow damper for use in the air flow system.

### BEST MODE FOR CARRYING OUT THE INVENTION

Referring now to the drawings, the humidifier of this invention is shown in first and second embodiments which differ from each other primarily in the manner of regulating the water supply to the evaporator pad. It will be appreciated as the description proceeds that this invention may be realized in a variety of embodiments and is useful in many different applications.

First Embodiment of the Invention

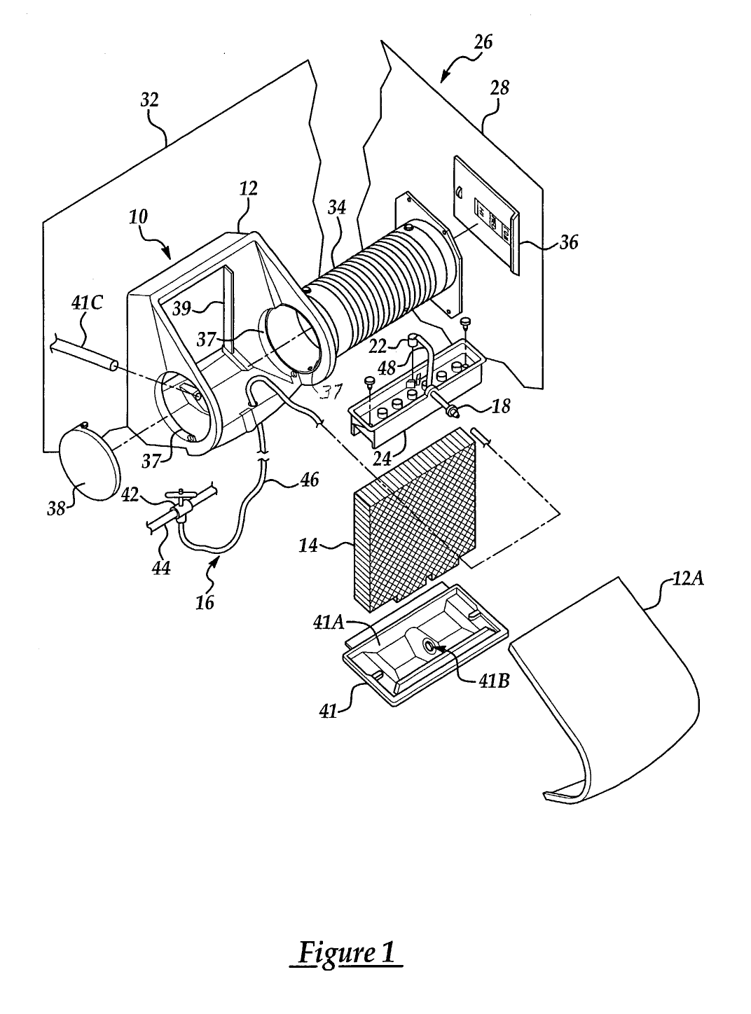

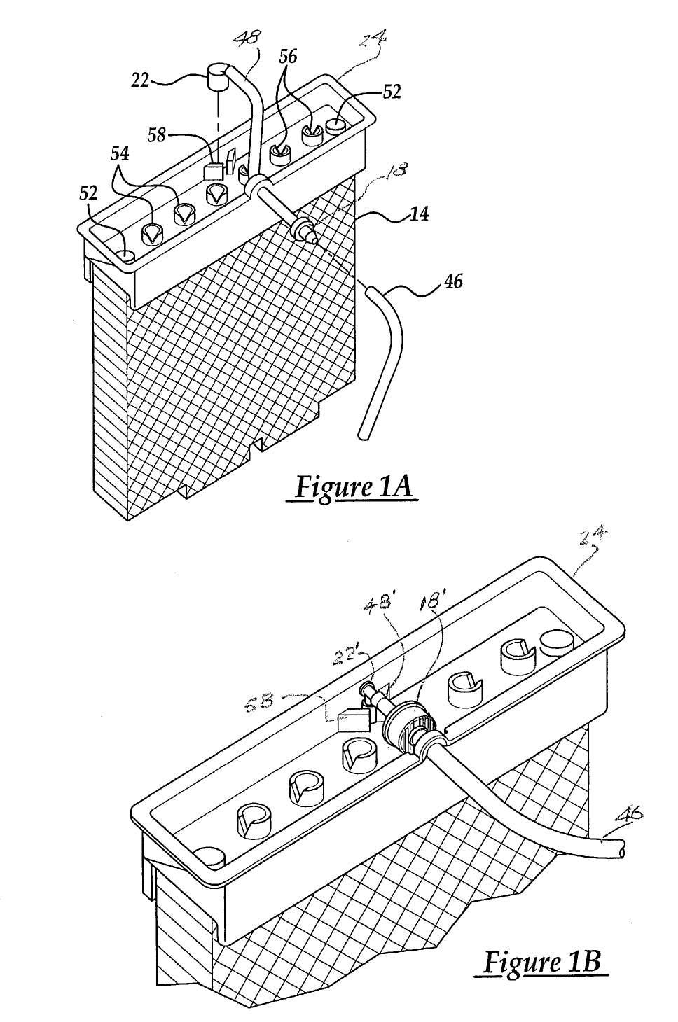

The humidifier 10 of this invention, in the first embodiment, will now be described with reference to FIGS. 1, 1A, 1B, 3A, 3B, 4A and 4B. In general, the humidifier 10 comprises a housing 12 which contains an evaporator pad 14. The water supply system includes a water supply line 16 which includes a drip nozzle 18 and extends to an elbow fitting 22. The elbow fitting supplies a controlled amount of water to a water distribution tray 24 and thence to the evaporator pad 14. The humidifier 10 is installed on a forced air furnace (part of which is indicated by arrow 26) and which includes a hot air plenum or duct 28 and a cold air plenum or duct 32. An air flow system extends from the hot air duct 28 through a flexible duct 34 to the housing 12 and thence through the evaporator pad 14 to the cold air duct 32. An adjustable air flow damper 36 is interposed between the hot air duct 28 and the inlet end of the flexible duct 34. It will be appreciated by those skilled in the art that the air flow direction may be reversed between the two ducts 28 and 32. For this purpose, the flexible duct 34 with the damper 36 would be connected with the cold air duct 32 and the humidifier housing 12 would be mounted on and in communication with the hot air duct 28.

The humidifier 10 will now be described in greater detail.

The housing 12 of the humidifier, as shown in FIG. 1, comprises a molded plastic body and also includes a molded plastic removable cover 12A. The housing body is provided with oppositely disposed circular openings 37 in the front portion of the left sidewall and the right sidewall, respectively, of the housing 12. As shown, the flexible duct 34 is coupled to the housing through the right-side opening 37 and the left-side opening 37 is closed by a removable cover plate 38. This permits the duct 34 to be connected to the left-side opening with the cover plate 38 on the right-side opening if the installation requires. The housing 12 is provided with a rectangular opening 39 in the rear wall which is aligned with a corresponding opening in the cold air duct 32 when the housing 12 is mounted on the cold air duct. As shown in FIG. 1A, a water distribution tray 24 is mounted on the evaporator pad 14. The assembled pad and tray are installed inside the housing with the pad covering the rectangular opening 39 and with the tray disposed between the upper edge of the opening and the top wall of the housing 12. Before the pad and tray assembly is installed in the housing, an overflow pan 41 is installed on the bottom wall of the housing 12 against the back wall thereof. The pan 41 is a single piece of molded plastic and includes the unitary shelf 41A which is shaped to accommodate the configuration of the bottom side of the evaporator pad 14. The pan 41 is also provided with a drain fitting 41B at a level above the bottom of the pan and a drain hose 41C is connected to the fitting.

The water supply system of the humidifier 10 will now be described in detail. The water supply line 16 includes a flexible plastic tube 46 which extends from a saddle valve 42 on a water pipe 44 of the household plumbing system near the furnace. The saddle valve is readily connected in a well known manner to the water pipe to form a T-connection with the pipe. The saddle valve has a valve handle which can be manually rotated to open or close the valve. The flexible tube 46 extends from the saddle valve 42 through an opening in the front edge of the bottom wall of the housing 12 and connects with the inlet end of the drip nozzle 18 which will be described below. The outlet end of the drip nozzle is connected by a riser tube 48 which extends through an opening in the front wall of a water distribution tray 24. The riser tube 48 is preferably made of a material such as soft copper, plastic or rubber which will hold its formed shape. The tube 48 terminates in an elbow fitting 22 which opens downwardly above the tray 24.

The water distribution tray 24 is mounted on the top edge of the evaporator pad 14 (as best shown in FIGS. 1A and 1B) and is held removably in place by a pair of headed studs 52 at opposite ends of the tray. The studs have a shank extending into the evaporator pad 14. The tray 24 has a flat bottom wall with a set of spaced drain holes therein each of which is surmounted by upstanding tubular members 54 extending through the bottom wall. Each of the tubular members has a V-shaped notch 56 which extends downwardly from the upper end of the tubular wall. The tray is also formed with a unitary catch basin 58 over which the elbow fitting 22 is located. The catch basin is triangular in shape with a flow passage at the apex of its inner walls which are somewhat higher above the bottom of the tray than the lower end of the V-shaped notches 56. This structural arrangement in the bottom of the tray 24 provides for substantially uniform distribution of water flow across the top edge of the evaporator pad 14 regardless of the water level in the tray.

FIG. 1B is a modification of water supply arrangement at the water distribution tray. As shown in FIG. 1B, the water distribution tray 24 is of the same construction as shown in FIG. 1A. However, the tube 46 of the water supply line extends through an opening in the front wall of the distribution tray to the inlet end of a drip nozzle 18′ which is disposed inside the water distribution tray. The outlet end of the drip nozzle 18′ is connected by a straight tube 48′ which terminates in an elbow fitting 22′ which opens downwardly into the catch basin 58. The drip nozzle 18′ will be described below.

The evaporator pad 14 is suitably a pad such as that described in U.S. Pat. No. 5,374,381 assigned to RPS Products. This patent discloses a pad with a honeycomb structure of plural sheets of expanded metal with expanded sheets of paper disposed between the metal sheets. Another preferred evaporator pad comprises a pad with a honeycomb structure which includes plural layers of expanded aluminum sheets. This pad can be used with a coating on the metal which keeps water from running off and may be a wicking material. Also it can be used without any coating on the metal.

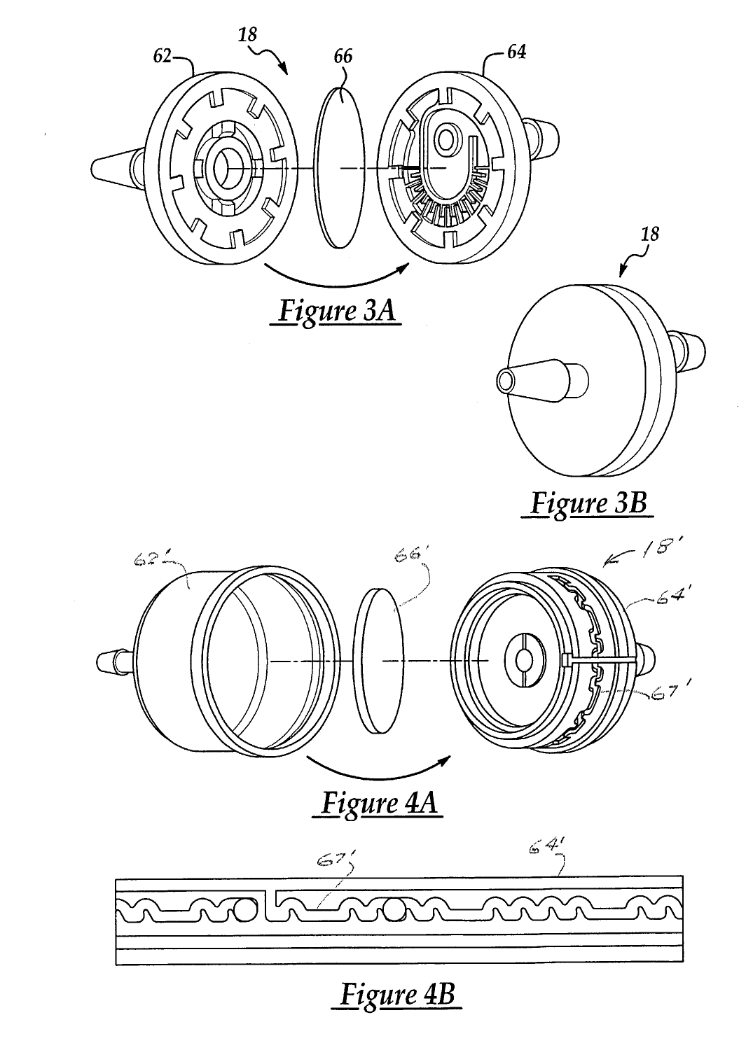

The drip nozzle 18 as shown in FIGS. 3A and 3B provides for a predetermined substantially constant, rate of flow of successive, discrete water drops from the outlet end of the nozzle, and hence from the fitting 22. The riser tube 48 contributes to the formation of discrete water drops at the fitting 22 by reason of the vertical section of the riser which terminates in the horizontal arm and the fitting 22, all of which provide a flow path having cross sectional area equal to or no smaller than outlet end of the flow restrictor.

The drip nozzle 18 is of a known design which is used in drip irrigation systems and which provides a high degree of reliability in operation and is available at very low cost. The nozzle 18 comprises three discrete parts, namely an inlet member 62, an outlet member 64 and a separator member 66. The inlet member 62 is made of molded plastic and with a circular disk shaped body and a unitary tubular inlet fitting both having a centered, axially extending flow path therethrough. The outlet member 64 comprises a plastic molded circular disk with a unitary tubular outlet fitting which is disposed eccentrically of the disk body with a flow path extending through the tubular fitting and through the outer wall of the disk shaped body. The separator member 66 comprises a thin circular disk which partially separates the inlet member from the outlet member. A tortuous flow path is formed by a plurality of closely spaced interdigitated fingers which reduce the flow rate so that discrete water drops are emitted from the outlet member 64.

As an example, the illustrative embodiment of the humidifier may use a drip nozzle which will produce a flow rate in the range of 1 to 2 gallons per hour with water pressure in the range of 20 to 65 pounds per square inch.

FIGS. 4A and 4B show the details of the drip nozzle 18′ which is a modification with respect to drip nozzle 18. A drip nozzle 18′ comprises 3 discrete parts, namely an inlet member 62′, an outlet member 64′ and a separator member 66′. In this drip nozzle the inlet member 62′ has an inlet fitting which is coaxial with the disc shaped body and the outlet member 64′ as inlet fitting which is coaxial with the disc shaped body and with the tubular inlet fitting. The separater member 66′ is a thin circular disc which separates the inlet member 62′ from the outlet member 64′ except for a flow restrictor connection which includes a torturous flow path 67′ on the circumferential surface of the outlet member 64′. This flow path is shown in FIG. 4B as a developed view of the circumferential surface of the outlet member 64′. The drip nozzle 18′ is rated for emitting drips with a flow rate of 0.5 gallons per hour with an inlet pressure of about 50 pounds per square inch.

The humidifier 10, as described above, is intended for operation with a forced air furnace during the heating season when the furnace is operated under the control of a thermostat in a conventional manner. In order to enable operation of the humidifier, the saddle valve 42 must be turned on to supply water to the evaporator pad 14. In this operative condition of the humidifier, the air flow through the cold air duct 32 is humidified by the bypass air from the hot air duct 28 through the flow damper 36 and the flexible duct 34 into the humidifier housing 12 and thence through the evaporator pad 14 into the cold air duct 32. Flow of the bypass air through the humidifier occurs when the furnace is turned on under the control of the thermostat in the usual manner. Thus, the warm air delivered to the house through the hot air duct 28 is humidified by the bypass air which passes through the evaporator pad and carries water vapor into the cold air duct at a location upstream of the heat exchanger of the furnace.

The degree of humidification provided by the humidifier 10 is adjustable by the manual setting of the slidable damper plate 36. The position of the damper plate controls the volume of bypass air and is suitable calibrated by index marks for three positions corresponding to high, medium and low humidity. With the damper plate in the high position, the bypass air flow is maximized and hence the degree of humidification is maximized.

FIG. 6 shows a modification for controlling the degree of humidification provided by the humidifier 10. In this modification, a rotary damper valve 36′ is installed on the air duct 28 and the flexible duct 34 is connected with the outlet of the damper valve 36′. The damper valve is manually actuated for selecting the degree of humidification. The valve is suitably calibrated by index marks for three positions corresponding to high, medium and low humidity.

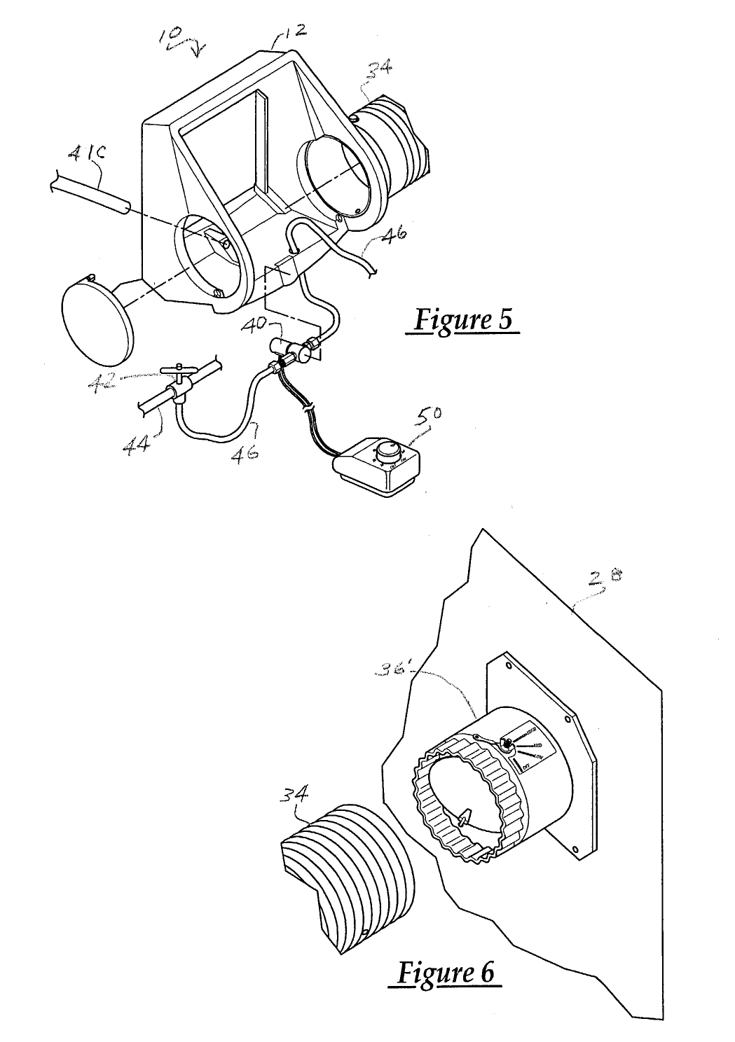

FIG. 5 shows a modification in which the water supply system of the humidifier 10 is automatically controlled to turn the water on and off as needed for humidification. For this purpose, a solenoid valve 40 is connected in the supply tube 46 and is operative to turn on the water supply to the humidifier when the valve is energized and to turn it off when the valve is deenergized. A humidistat 50 has a manual control knob for setting the desired degree of humidity. The humidistat is electrically connected with the solenoid valve 40 and is operative to turn on the water supply to the humidifier 10 when the furnace is on and the humidity sensed by the humidistat is below the setting of the humidistat.

Second Embodiment of the Invention

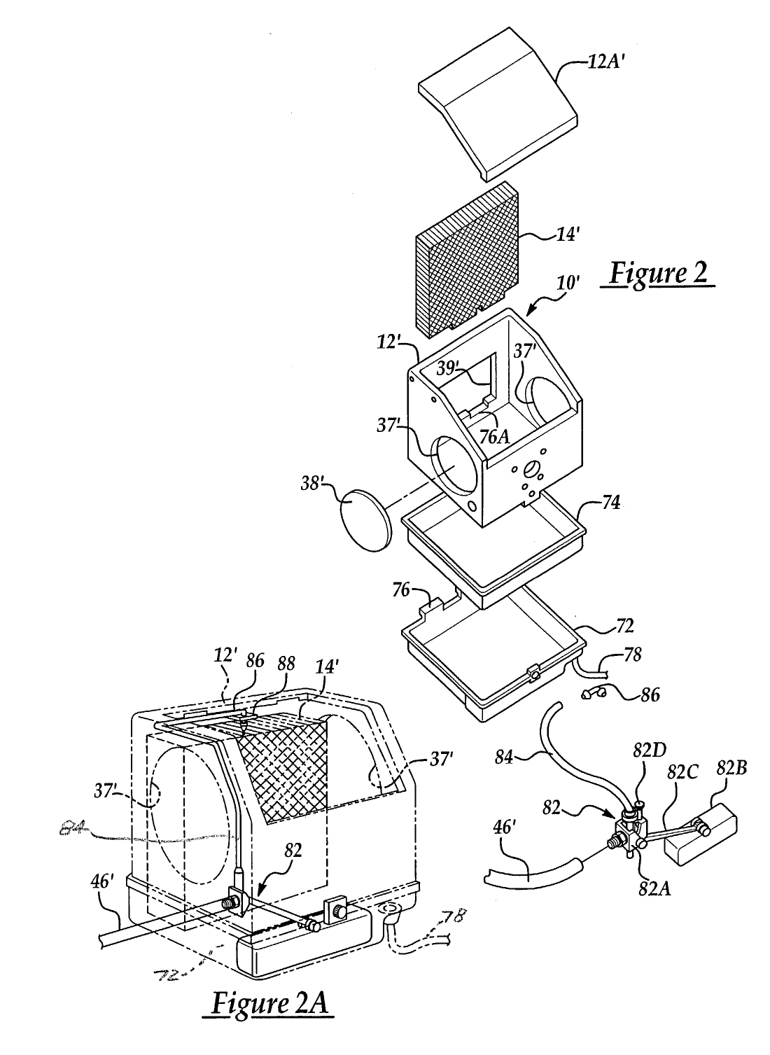

FIGS. 2 and 2A depict a second embodiment of the invention. The first and second embodiments are similar to each other except for the water supply systems. It is noted that the housing and air flow systems are functionally the same but are of somewhat different design configurations. Accordingly, the corresponding components in the two embodiments are designated by the same reference characters except that a prime symbol is added to the reference characters in the second embodiment.

As shown in FIGS. 2 and 2A, the humidifier 10′ comprises a housing 12′ with a removable cover 12A′ and encloses an evaporator pad 14′ which is disposed in front of the rectangular opening 39′. The housing also comprises a removable pan 72 which constitutes the bottom of the housing 12′. A disposable liner 74 fits inside the pan 72 and is adapted for easy replacement by the homeowner when needed. The removable pan 72 is provided with a pair of hinge tabs 76 at the upper edge of the rear wall to mate with corresponding notches 76A in the rear wall of the housing 12′. The right front corner of the pan 72 has a shallow portion with a fitting for connection of a drain tube 78. This allows excess water in the pan 72 to be drained from the humidifier.

In this second embodiment, water is supplied to the humidifier 10′ from a saddle valve (not shown) connected with a household water pipe like that in humidifier 10 and serving as a shut off for the humidifier water. The water supply tube 46′ is connected to a float valve 82 which has an outlet connected through a tube 84 to an elbow fitting 86 which is mounted on a bracket arm 88 above the evaporator pad 14′. The float valve 82 includes a float 82B connected to the valve body 82A. The float 82B is pivotally connected by an actuating arm 82C for opening and closing the valve in a conventional manner. The valve body 82A includes an adjustment screw 82D for setting the valve turn-on point at the desired water level in the pan. The float valve 82 is of a conventional type which uses a squeeze cam actuated by the float arm to flatten a squeeze tube in the valve for shutting off the water in accordance with the set point of the float. The set point of the float is preferably adjusted to maintain a water level which is sufficiently high to wet the lower edge of the evaporator pad. With this arrangement, the wicking action of the evaporator pad from the water in the pan and from the intermittent stream of water through the fitting 86 will provide substantially uniform wetting of the pad throughout the entire volume of the pad. It is noted that a water distribution tray like that shown in the first embodiment could be used.

### CONCLUSION

Although this invention has been described with reference to a particular embodiment, not to be construed in a limiting sense. Many variations and modifications of the invention will now occur to those skilled in the art.

1. A flow-through humidifier comprising:
an evaporator pad,
a drip nozzle having a housing with an inlet fitting and an outlet fitting and a flow restrictor therebetween for producing discrete water drops at said outlet fitting,
a first water supply tube having an outlet and connected with said inlet fitting of said drip nozzle and having an inlet end adapted for connection to a source of pressurized water,
a second water supply tube having an inlet end connected with said outlet fitting of said drip nozzle and having an outlet end disposed in a gravity flow relation with said evaporator pad,
whereby water is supplied in discrete water drops to said evaporator pad by gravity flow of said water drops from said outlet end of said second water supply tube.

2. A flow-through humidifier as defined in claim 1 including:
a water distribution tray disposed above said evaporator pad for receiving said flow of water drops and distributing water to different parts of said evaporator pad.

3. A flow-through humidifier as defined in claim 2 including a housing, and wherein:
said evaporator pad is mounted on said housing and comprises a substantially rectangular panel disposed in a vertical plane,
said water distribution tray being disposed above the upper edge of said panel,
said water distribution tray having an open top and a closed peripheral side wall with a unitary bottom wall for containing water therein, a plurality of tubular members extending through said bottom wall and spaced transversely from each other and having a uniform height above said bottom wall whereby water collects in said tray and is distributed to said evaporator pad through said tubular members.

4. A flow-through humidifier as defined in claim 3 wherein:
said drip nozzle is disposed outside of said water distribution tray and the second water supply tube extends from said drip nozzle to a location with its outlet end disposed above said water distribution tray for delivering said flow of water drops thereto.

5. A flow-through humidifier as defined in claim 4 wherein said second water supply tube is secured to said water distribution tray and has its outlet end disposed above the peripheral side wall of said tray.

6. A flow-through humidifier as defined claim 3 wherein:
said drip nozzle is disposed inside said water distribution tray and said first water supply tube is secured to said side wall of said water distribution tray.

7. A flow-through humidifier as defined in claim 1 including:
a solenoid valve connected in said first water supply tube for turning on and off the flow of water in said first water supply tube.

8. A flow-through humidifier as defined in claim 7 including:
a humidistat electrically connected with said solenoid valve for turning said water supply on and off.

9. A flow through humidifier as defined in claim 3 including:
a humidifier housing inlet air duct adapted to be connected with a first furnace air duct,
a humidifier housing outlet air duct adapted to be connected with a second furnace air duct,
said evaporator pad being disposed between said humidifier housing air ducts, and
an adjustable damper disposed in one of said humidifier housing air ducts for restricting the air flow through said evaporator pad.

10. A flow through humidifier as defined in claim 10 wherein:
said adjustable damper is a slidably mounted plate extending into said one of said humidifier housing air ducts.

11. A flow through humidifier as defined in claim 10 wherein:
said adjustable damper is a rotably mounted plate disposed inside said one of said humidifier housing air ducts.

12. A flow-through humidifier as defined in claim 1 including:
a housing,
an evaporator pad comprising a rectangular panel disposed in a vertical plane and supported by said housing,
a water reservoir disposed at the bottom of said housing,
a float valve connected in said first water supply tube and having a valve actuating float for opening and closing said float valve, said float being disposed in said water reservoir,
whereby water is supplied in a stream to said evaporation pad only when said float valve is open.

13. A flow-through humidifier as defined in claim 12 wherein:
said evaporator pad is disposed above said reservoir and the lower end of said evaporator pad is immersed in water when the water level in the reservoir corresponds to the upper set point level of said float valve.
